(19) United States
(12) Patent Application Publication
(10) Pub. No.: US 2026/0006377 A1
(43) Pub. Date: Jan. 1, 2026

(54) SIGNAL PROCESSING METHOD, DEVICE, AND COMPUTER-READABLE STORAGE MEDIUM

(71) Applicant: HARMAN INTERNATIONAL INDUSTRIES, INCORPORATED, Stamford, CT (US)

(72) Inventors: Yu-Tin CHAO, Taipei City (TW); Hongwei YU, Shenzhen (CN); Huaming CHEN, Shenzhen (CN)

(21) Appl. No.: 19/206,701

(22) Filed: May 13, 2025

(30) Foreign Application Priority Data
Jun. 26, 2024 (CN) 2024108407433

(51) Int. Cl. H04R 3/00; H04R 3/04

(52) U.S. Cl. CPC H04R 3/005; H04R 3/04; H04R 2430/01

(57) ABSTRACT

Embodiments of the present disclosure provide a signal processing method and device, and a computer-readable storage medium. The signal processing method includes: determining a gain adjustment ratio between a first sound input signal generated based on a built-in microphone of an electronic device and a second sound input signal generated based on an external microphone of the electronic device, based on respective signal responses of the built-in microphone and the external microphone; adjusting at least one of the first sound input signal and the second sound input signal based on the gain adjustment ratio, to obtain a first input signal and a second input signal; and combining the first input signal and the second input signal to obtain a combined signal.

### CROSS-REFERENCE TO RELATED APPLICATIONS

This application claims priority benefit to Chinese Patent Application Number 202410840743.3 entitled “SIGNAL PROCESSING METHOD, DEVICE, AND COMPUTER-READABLE STORAGE MEDIUM”, filed Jun. 26, 2024, the contents of which are incorporated by reference herein in its entirety.

### BACKGROUND

### Field of the Various Embodiments

The present disclosure relates to the fields of signal processing, artificial intelligence, and the like, and more specifically, to a signal processing method, apparatus, and device, and a computer-readable storage medium.

### Description of the Related Art

As the information contained in audio signals becomes more and more complicated, modern electronic devices have higher and higher requirements for the quality of audio signals. It has become the focus of current research in this field as to how to effectively process audio signals to obtain high-quality audio signals so as to more accurately complete the various functions of electronic devices and thus improve user experience.

For example, a wearable electronic device such as a headset may include both a built-in microphone and an external microphone. Among them, the external microphone can acquire the sound transmitted through the air; and the built-in microphone can acquire the sound transmitted through solid vibration, such as the sound conducted to the microphone through the bones.

External microphones can acquire sound signals in various frequency bands, but are susceptible to noises (e.g., wind noise). Therefore, a built-in microphone (e.g., a bone conduction microphone) can be used to assist in improving the quality of the sound signal so as to enhance the clarity of the sound.

Built-in microphones generally have good sound insulation and are capable of reducing interferences from external noises and more easily capturing sound conducted through the bones (especially when the electronic device is pressed against the head or face). However, during bone conduction, sound vibrations are transmitted directly to the inner ear through the bones. As high-frequency audio signals may be attenuated when transmitted through bones, bone conduction is generally more effective in transmitting low-frequency audio signals. That is, the low-frequency part is dominant while the high-frequency component is lacking in the audio input signal generated by the built-in microphone. The quality of the high-frequency part of the audio input signal generated by the built-in microphone may be inferior to the sound directly transmitted through the air, resulting in a rather low sound.

It can be seen that neither the audio input signal generated by the built-in microphone nor the audio input signal generated by the external microphone can accurately reflect the information of the sound actually input to the microphone. Therefore, it has become the focus of current research in the field of audio signal processing as to how to process the audio input signal generated based on the built-in microphone and/or the external microphone to obtain a higher quality audio signal, so as to clearly and truly reflect the information of the sound actually input to the microphone.

### SUMMARY

In order to improve the signal quality, the present disclosure provides a signal processing method, including: determining a gain adjustment ratio between a first sound input signal generated based on a built-in microphone of an electronic device and a second sound input signal generated based on an external microphone of the electronic device, based on respective signal responses of the built-in microphone and the external microphone; adjusting at least one of the first sound input signal and the second sound input signal based on the gain adjustment ratio, to obtain a first input signal and a second input signal; and combining the first input signal and the second input signal to obtain a combined signal, wherein a proportion of the first input signal in the combined signal is reduced with an increase of frequency in a first predetermined frequency band, the first predetermined frequency band including a part of an overlapping frequency band of the first input signal and the second input signal where frequency is greater than a first predetermined frequency threshold.

According to an embodiment of the present disclosure, determining a gain adjustment ratio between a first sound input signal generated based on a built-in microphone of an electronic device and a second sound input signal generated based on an external microphone of the electronic device includes: obtaining a gain ratio between a signal response of the built-in microphone and a signal response of the external microphone to determine the gain adjustment ratio, by adopting at least one of time domain analysis and frequency domain analysis.

According to an embodiment of the present disclosure, combining the first input signal and the second input signal to obtain a combined signal includes: for a frequency band lower than a lower frequency limit of the first predetermined frequency band, combining the first input signal and the second input signal according to a first combination ratio to obtain a first combined signal; for a frequency band within the first predetermined frequency band, combining the first input signal and the second input signal according to a second combination ratio that is reduced with an increase of frequency to obtain a second combined signal; for a frequency band higher than an upper frequency limit of the first predetermined frequency band, combining the first input signal and the second input signal according to a third combination ratio to obtain a third combined signal; and determining the combined signal based on the first combined signal, the second combined signal, and the third combined signal, wherein the first combination ratio, the second combination ratio, and the third combination ratio all represent proportion of the first input signal in the combined signal, wherein the first combination ratio is greater than the second combination ratio, and the second combination ratio is greater than the third combination ratio.

According to an embodiment of the present disclosure, the signal processing method further includes: reducing the noise in the combined signal to obtain a first noise-reduced signal by using a neural network model, wherein the neural network model has a higher noise reduction ability for low-frequency signals than high-frequency signals.

An embodiment of the present disclosure further provides a signal processing method, including: determining a gain adjustment ratio based on a gain ratio between a first sound input signal generated based on a built-in microphone of an electronic device and a second sound input signal generated based on an external microphone of the electronic device; adjusting at least one of the first sound input signal and the second sound input signal based on the gain adjustment ratio, to obtain a first input signal and a second input signal; and combining the first input signal and the second input signal to obtain a combined signal, wherein a proportion of the first input signal in the combined signal is reduced with an increase of frequency in a first predetermined frequency band, wherein the first predetermined frequency band includes a part of an overlapping frequency band of the first input signal and the second input signal where frequency is greater than a first predetermined frequency threshold.

An embodiment of the present disclosure further provides a signal processing method, including: acquiring a first sound input signal generated based on a built-in microphone of an electronic device, a second sound input signal generated based on an external microphone of the electronic device, and an expected signal response; adjusting at least one of the first sound input signal and the second sound input signal based on the expected signal response to obtain a first input signal and a second input signal; and combining the first input signal and the second input signal to obtain a combined signal, wherein a proportion of the first input signal in the combined signal is reduced with an increase of frequency in a first predetermined frequency band, the first predetermined frequency band including a part of an overlapping frequency band of the first input signal and the second input signal where frequency is greater than a first predetermined frequency threshold.

An embodiment of the present disclosure further provides a signal processing device, including a memory and a processor coupled to the memory and configured to execute the above method.

An embodiment of the present disclosure further provides a signal processing apparatus including a ratio determination module configured to: determine a gain adjustment ratio between a first sound input signal generated based on a built-in microphone of an electronic device and a second sound input signal generated based on an external microphone of the electronic device, based on respective signal responses of the built-in microphone and the external microphone; a signal adjustment module configured to: adjust at least one of the first sound input signal and the second sound input signal based on the gain adjustment ratio, to obtain a first input signal and a second input signal; and a signal combination module configured to: combine the first input signal and the second input signal to obtain a combined signal, wherein a proportion of the first input signal in the combined signal is reduced with an increase of frequency in a first predetermined frequency band, the first predetermined frequency band including a part of an overlapping frequency band of the first input signal and the second input signal where frequency is greater than a first predetermined frequency threshold.

An embodiment of the present disclosure further provides a signal processing apparatus including a ratio determination module configured to: determine a gain adjustment ratio based on a gain ratio between a first sound input signal generated based on a built-in microphone of an electronic device and a second sound input signal generated based on an external microphone of the electronic device; a signal adjustment module configured to: adjust at least one of the first sound input signal and the second sound input signal based on the gain adjustment ratio, to obtain a first input signal and a second input signal; and a signal combination module configured to: combine the first input signal and the second input signal to obtain a combined signal, wherein a proportion of the first input signal in the combined signal is reduced with an increase of frequency in a first predetermined frequency band, the first predetermined frequency band including a part of an overlapping frequency band of the first input signal and the second input signal where frequency is greater than a first predetermined frequency threshold.

An embodiment of the present disclosure further provides a signal processing apparatus including a signal acquisition module configured to: acquire a first sound input signal generated based on a built-in microphone of an electronic device, a second sound input signal generated based on an external microphone of the electronic device, and an expected signal response; a signal adjustment module configured to: adjust at least one of the first sound input signal and the second sound input signal based on the expected signal response to obtain a first input signal and a second input signal; and a signal combination module configured to: combine the first input signal and the second input signal to obtain a combined signal, wherein a proportion of the first input signal in the combined signal is reduced with an increase of frequency in a first predetermined frequency band, the first predetermined frequency band including a part of an overlapping frequency band of the first input signal and the second input signal where frequency is greater than a first predetermined frequency threshold.

An embodiment of the present disclosure further provides a computer program product including computer software codes which, when executed by a processor, provide the above method.

An embodiment of the present disclosure further provides a computer-readable storage medium having computer-executable instructions stored thereon, which, when executed by a processor, provide the above method.

The signal processing method of the present disclosure performs gain adjustment on at least one of a sound input signal generated based on a built-in microphone of an electronic device and a sound input signal generated based on an external microphone of the electronic device, and smoothly combines the adjusted signals. In this way, a combined signal of higher quality (i.e., a signal that is clearer and better able to reflect the information of the real sound) can be obtained in the case of a low signal-to-noise ratio of the sound input signal generated based on the external microphone of the electronic device. Further, the noise in the combined signal can be reduced by a neural network model to further improve the quality of the combined signal. The signal processing method of the present disclosure can improve the user experience in application scenarios such as sound acquisition and voice communication.

### BRIEF DESCRIPTION OF THE DRAWINGS

In order to more clearly illustrate the technical solutions of the embodiments of the present disclosure, the drawings required for describing the embodiments are briefly introduced below. Apparently, the drawings in the following description show only some exemplary embodiments of the present disclosure, and for those of ordinary skills in the art, other drawings can also be obtained based on these drawings without making creative effort.

Here, in the drawings:

FIGS. 1A-1B are schematic diagrams illustrating application scenarios according to embodiments of the present disclosure;

FIGS. 2A-2C are schematic flowcharts illustrating signal processing methods according to embodiments of the present disclosure;

FIGS. 3A-3B are schematic diagrams illustrating signals according to embodiments of the present disclosure;

FIGS. 4A-4B are schematic diagrams illustrating signal processing procedures according to embodiments of the present disclosure; and

FIGS. 5A-5C are schematic diagrams illustrating the composition of signal processing apparatuses according to embodiments of the present disclosure.

### DETAILED DESCRIPTION

In order to make the objectives, technical solutions, and advantages of the present disclosure more obvious, exemplary embodiments according to the present disclosure will be described in detail below with reference to the drawings. Apparently, the described embodiments are merely some of the embodiments of the present disclosure, rather than all the embodiments of the present disclosure. It should be understood that the present disclosure is not limited by the exemplary embodiments described herein.

Further, in this specification and the drawings, substantially the same or similar steps and elements are denoted by the same or similar reference numerals, and duplicated description of these steps and elements will be omitted.

Further, in this specification and the drawings, elements are described in the singular or in the plural depending on the embodiment. However, the singular and plural forms are appropriately selected for the presented cases merely for convenience of explanation and are not intended to limit the present disclosure thereto. Therefore, a singular form may include a plural form and a plural form may also include a singular form, unless expressively stated otherwise in the context.

In addition, in this specification and the drawings, the terms “first/second” involved are merely used to distinguish similar objects and do not represent a specific ordering of the objects. It can be understood that “first/second” can be interchanged in a specific order or sequence where permitted, so that the embodiments of the present disclosure described herein can be implemented in an order other than that illustrated or described herein.

Further, in this specification and the drawings, unless expressly stated otherwise, “connection” does not necessarily mean “direct connection” or “direct contact”; rather, “connection” may refer to both a fixation function and electrical communication herein.

Relevant concepts of the present disclosure are introduced in the following.

Artificial Intelligence (AI) is the theory, method, technology, and application system that uses digital computers or machines controlled by digital computers to simulate, extend, and expand human intelligence, perceive the environment, acquire knowledge, and use knowledge to obtain the optimum results. In other words, artificial intelligence is a comprehensive technology in computer science that attempts to understand the essence of intelligence and produce a new type of intelligent machine that can respond in a similar way to human intelligence. Artificial intelligence is the study of the design principles and implementation methods of various intelligent machines, so that the machines have the functions of perception, reasoning, and decision-making.

Applying artificial intelligence technology to the field of signal processing can accomplish tasks such as noise signal recognition, signal noise reduction, signal enhancement, and signal information extraction. For example, in the case where noise reduction for audio signal is achieved by using artificial intelligence technology, the noisy audio signal can be input into a neural network model, which can analyze the noisy audio signal to distinguish the desired sound (e.g., speech, music) signal and the background noise signal. Then the noise signal can be suppressed (e.g., reduced or eliminated) while preserving the integrity of the desired sound signal by using audio filtering technology. After suppressing the noise signal, the quality of the desired sound signal can further be improved by using technologies such as signal equalization and speech enhancement.

In summary, the present disclosure relates to the field of signal processing, artificial intelligence, and the like. The embodiments of the present disclosure will be further described below in conjunction with the drawings.

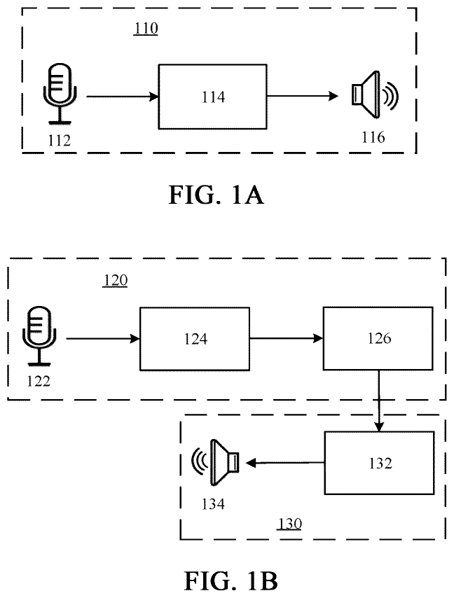

FIG. 1A is a schematic diagram illustrating an application scenario according to an embodiment of the present disclosure.

As shown in FIG. 1A, an electronic device 110 includes a microphone 112 for capturing sound and generating a sound input signal; a processor 114 configured to process the sound input signal generated by the microphone to obtain a processed sound signal of higher quality; and a sound output apparatus 116 for outputting sound based on the processed sound signal.

It should be noted that, in FIG. 1A, the microphone 112 may include a built-in microphone and an external microphone of the electronic device. Among them, the external microphone can acquire the sound transmitted through the air; and the built-in microphone can acquire the sound transmitted through solid vibration, such as the sound conducted to the microphone through the bones (i.e., in this case, the built-in microphone is a bone conduction microphone).

The built-in microphone usually has a good sound insulation effect, but the low-frequency part is dominant and high-frequency components are lacking in the generated audio signal, and the external microphone can acquire sound signals in various frequency bands, but is susceptible to noises (such as wind noise). Therefore, the processor 114 can be used to process the audio input signal generated based on the built-in microphone and/or the external microphone to obtain an audio signal of higher quality, thereby clearly and accurately reflecting the information of the sound actually input to the microphone.

As an example, the processor 114 can perform first processing including: determining a gain adjustment ratio between a first sound input signal generated based on the built-in microphone of the electronic device and a second sound input signal generated based on the external microphone of the electronic device, based on respective signal responses of the built-in microphone and the external microphone; adjusting at least one of the first sound input signal and the second sound input signal based on the gain adjustment ratio, to obtain a first input signal and a second input signal; and combining the first input signal and the second input signal to obtain a combined signal, where a proportion of the first input signal in the combined signal is reduced with an increase of frequency in a first predetermined frequency band, the first predetermined frequency band including a part of an overlapping frequency band of the first input signal and the second input signal where frequency is greater than a first predetermined frequency threshold.

As another example, the processor 114 can further perform second processing including: determining a gain adjustment ratio based on a gain ratio between a first sound input signal generated based on the built-in microphone of the electronic device and a second sound input signal generated based on the external microphone of the electronic device; adjusting at least one of the first sound input signal and the second sound input signal based on the gain adjustment ratio, to obtain a first input signal and a second input signal; and combining the first input signal and the second input signal to obtain a combined signal, where a proportion of the first input signal in the combined signal is reduced with an increase of frequency in a first predetermined frequency band, the first predetermined frequency band including a part of an overlapping frequency band of the first input signal and the second input signal where frequency is greater than a first predetermined frequency threshold.

As another example, the processor 114 can further perform third processing including: acquiring a first sound input signal generated based on the built-in microphone of the electronic device, a second sound input signal generated based on the external microphone of the electronic device, and an expected signal response; adjusting at least one of the first sound input signal and the second sound input signal based on the expected signal response to obtain a first input signal and a second input signal; and combining the first input signal and the second input signal to obtain a combined signal, where a proportion of the first input signal in the combined signal is reduced with an increase of frequency in a first predetermined frequency band, the first predetermined frequency band including a part of an overlapping frequency band of the first input signal and the second input signal where frequency is greater than a first predetermined frequency threshold.

It should be understood that the processor 114 can perform one or more of the first processing, the second processing, or the third processing described above. For example, the processor 114 can determine the processed sound signal provided to the sound output apparatus 116 based on a combined signal (e.g., a weighted average of a plurality of combined signals) obtained through one or more of the first processing, the second processing, or the third processing described above.

Further, in addition to the first processing, the second processing, and the third processing, the processor 114 can further perform other processing. For example, in the case where the first sound input signal and the second sound input signal are acquired, the processor 114 can perform one or more of time alignment, phase alignment, filtering, and noise reduction on the first sound input signal and the second sound input signal to obtain the preprocessed first sound input signal and second sound input signal, and further obtain the combined signal based on the preprocessed first sound input signal and second sound input signal. After obtaining the combined signal, the processor 114 can further perform post-processing operations such as filtering, noise reduction, and analysis on the combined signal.

It should be noted that the electronic device 110 in FIG. 1A may include other components in addition to the components shown in the figure. The microphone 112 in the present disclosure may be a general term for various sound receiving apparatuses, and the sound output apparatus 116 may be a headset, a speaker, or the like, which is not limited herein.

For the application scenario shown in FIG. 1A, after a sound input signal is generated by using the microphone 112 of the electronic device 110, the processor 114 of the electronic device 110 can process the sound input signal generated by the microphone and provide the processed sound signal to the sound output apparatus 116 of the electronic device 110, so that the sound output apparatus 116 outputs sound to the user based on the processed sound signal.

According to an embodiment of the present disclosure, the electronic device 110 may be various sound amplification products (e.g., hearing aids, auxiliary listening devices, personal sound amplification products (PSAPs), and the like).

According to an embodiment of the present disclosure, the processor 114 can process the first sound input signal and the second sound input signal in units of frames, and provide the processed sound signals to the sound output apparatus 116 in a timely manner, so that the sound output apparatus 116 outputs the sound to the user in a timely manner, thereby reducing the delay between the sound input to the microphone and the sound received by the user, and improving the user experience.

FIG. 1B is a schematic diagram illustrating an application scenario according to an embodiment of the present disclosure.

As shown in FIG. 1B, the electronic device 120 includes a microphone 122 for capturing sound and generating a sound input signal; a processor 124 configured to process the sound input signal generated by the microphone to obtain a processed sound signal of higher quality; and a signal sending apparatus 126 for sending the processed sound signal to another electronic device (e.g., electronic device 130).

The electronic device 130 includes a signal receiving apparatus 132 for communicating with the signal sending apparatus 126 to receive a processed sound signal from the electronic device 120; and a sound output apparatus 134 for outputting sound based on the processed sound signal.

It should be understood that the electronic device 120 and the electronic device 130 in FIG. 1B may include other components in addition to the components shown in the figure. The microphone 122 in FIG. 1B may have similar functions to the microphone 112 in FIG. 1A, the processor 124 in FIG. 1B may have similar functions to the processor 114 in FIG. 1A, and the sound output apparatus 134 in FIG. 1B may have similar functions to the sound output apparatus 116 in FIG. 1A, and duplicated description thereof will be omitted herein.

For the application scenario shown in FIG. 1B, after a sound input signal is generated by using the microphone 122 of the electronic device 120, the processor 124 of the electronic device 120 can process the sound input signal generated by the microphone and provide the processed sound signal to the signal sending apparatus 126 of the electronic device 120 to send the processed sound signal to the signal receiving apparatus 132 of the electronic device 130. Then, the signal receiving apparatus 132 of the electronic device 130 can provide the processed sound signal to the sound output apparatus 134 of the electronic device 130, so that the sound output apparatus 134 outputs sound to the user based on the processed sound signal.

According to an embodiment of the present disclosure, the electronic device 120 may be a headset, a mobile phone, a computer, a wearable device (e.g., a virtual reality electronic device), or the like, which is not limited herein.

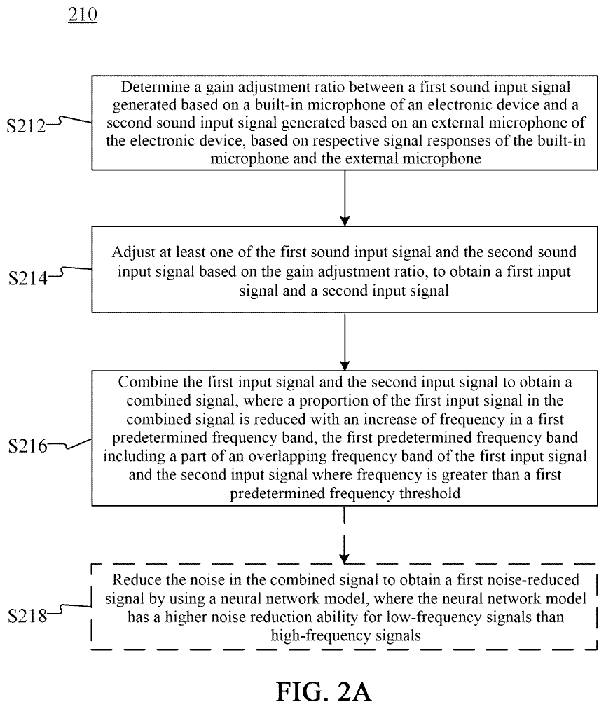

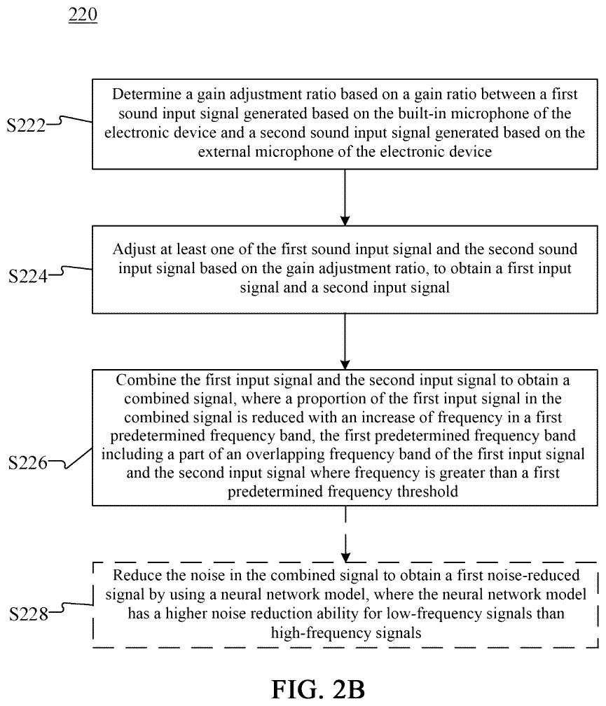

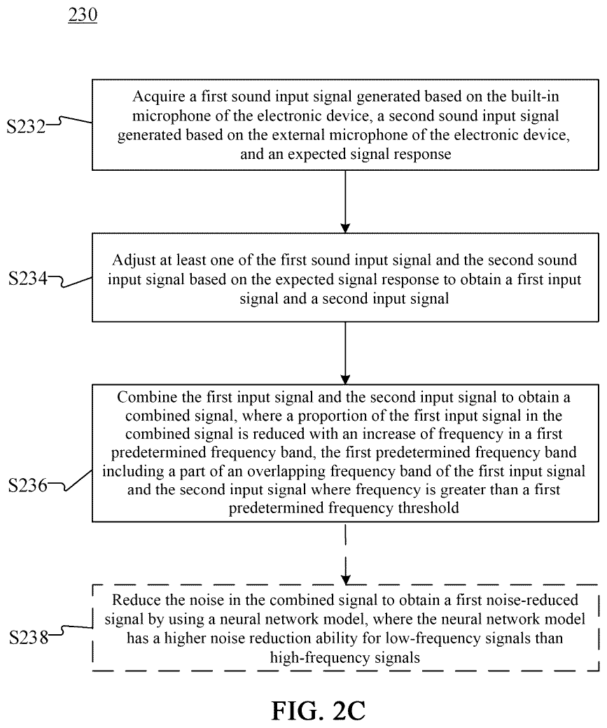

FIG. 2A is a schematic flowchart illustrating a signal processing method 210 according to an embodiment of the present disclosure.

In step S212, a gain adjustment ratio between a first sound input signal generated based on a built-in microphone of an electronic device and a second sound input signal generated based on an external microphone of the electronic device is determined based on respective signal responses of the built-in microphone and the external microphone.

According to an embodiment of the present disclosure, the signal response reflects the gain characteristic of the signal generated by the microphone for the input sound, which can be obtained based on a delivery test of the microphone. The signal response may be reflected by the energy or amplitude of the signal. For example, the signal response may be an impulse response or a frequency response of the microphone.

According to an embodiment of the present disclosure, a gain ratio between the signal response of the built-in microphone and the signal response of the external microphone can be acquired by adopting at least one of time domain analysis and frequency domain analysis to determine the gain adjustment ratio.

According to an embodiment of the present disclosure, in a case that the time domain analysis is adopted, the gain adjustment ratio can be determined by: performing low-pass filtering on the signal response of the built-in microphone and the signal response of the external microphone respectively to obtain a first filtered signal and a second filtered signal; and determining the gain adjustment ratio based on a gain ratio between the first filtered signal and the second filtered signal.

It should be understood that the gain ratio between the first filtered signal and the second filtered signal may vary over time. Optionally, the gain ratio between the first filtered signal and the second filtered signal may be an average gain ratio over a period of time.

According to an embodiment of the present disclosure, in a case that frequency domain analysis is adopted, the gain adjustment ratio can be determined by: determining a critical frequency at which a gain in the signal response of the built-in microphone is greater than or equal to a predetermined gain threshold; determining a first gain adjustment ratio, based on a first gain ratio between the signal response of the built-in microphone and the signal response of the external microphone when a frequency is lower than the critical frequency and a second gain ratio between the signal response of the built-in microphone and the signal response of the external microphone when the frequency is greater than or equal to the critical frequency; determining a second gain adjustment ratio, based on a third gain ratio between the signal response of the external microphone when the frequency is lower than the critical frequency and the signal response of the external microphone when the frequency is greater than or equal to the critical frequency; and determining the gain adjustment ratio based on at least one of the first gain adjustment ratio and the second gain adjustment ratio.

The first gain adjustment ratio can be used for reflecting the difference between the signal response of the built-in microphone and the signal response of the external microphone (i.e., the inter-channel difference), and the second gain adjustment ratio can be used for reflecting the difference between the signal response of the external microphone at a low frequency and the signal response of the external microphone a high frequency (i.e., the intra-channel difference). As an example, the first gain adjustment ratio gᵢₙₜₑᵣ can be calculated based on formula (1), and the second gain adjustment ratio gᵢₙₜᵣₐ can be calculated based on formula (2):

$${g}_{inter} = α * ( \frac{{L}_{FB}}{{L}_{FF}} ) + ( 1 - α ) * ( \frac{{H}_{FB}}{{H}_{FF}} ) \qquad ( 1 )$$

$${g}_{intra} = ( \frac{{L}_{FF}}{{H}_{FF}} ) , \qquad ( 2 )$$

where L_{FB} and L_{FF} are respectively the gain corresponding to the signal response of the built-in microphone when the frequency is lower than the critical frequency and the gain corresponding to the signal response of the external microphone when the frequency is lower than the critical frequency; H_{FB} and H_{FF} are respectively the gain corresponding to the signal response of the built-in microphone when the frequency is higher than the critical frequency and the gain corresponding to the signal response of the external microphone when the frequency is higher than the critical frequency; and the adjustment coefficient ais used for adjusting the ratio between the first gain ratio

$$\frac{{L}_{FB}}{{L}_{FF}}$$

and the second gain ratio

$$\frac{{H}_{FB}}{{H}_{FF}} .$$

According to another embodiment of the present disclosure, in a case that frequency domain analysis is adopted, the gain adjustment ratio can also determined by: determining a gain ratio between the signal response of the built-in microphone and the signal response of the external microphone for each frequency bin in the frequency domain analysis to determine the gain adjustment ratio.

It should be noted that the frequency bin in the present disclosure is a common term in frequency domain analysis, which can be used to represent the frequency interval or resolution of the frequency axis.

By determining the gain ratio between the signal response of the built-in microphone and the signal response of the external microphone for each frequency bin, at least one of the first sound input signal and the second sound input signal can be adjusted more finely.

It should be understood that in the various processes of gain ratio calculation described above, the gain ratio is usually obtained by dividing two gain values. In order to prevent the divided gain value from being too small and the gain ratio from being too large, a predetermined parameter ε can be added to the divided gain value, which is then used as the dividend, or an upper limit can be set for the gain ratio.

In step S214, at least one of the first sound input signal and the second sound input signal is adjusted based on the gain adjustment ratio, to obtain a first input signal and a second input signal.

According to an embodiment of the present disclosure, the first sound input signal can be adjusted based on the gain adjustment ratio so that the gain of the first input signal obtained after adjustment is equalized with the gain of the second sound input signal in a predetermined ratio (e.g., 1:1, 4:6, and so forth); or, the second sound input signal can be adjusted based on the gain adjustment ratio so that the gain of the second input signal obtained after adjustment is equalized with the gain of the first sound input signal in a predetermined ratio; or, both the first sound input signal and the second sound input signal can be adjusted based on the gain adjustment ratio so that the gain of the first input signal obtained after adjustment is equalized with the gain of the second input signal obtained after adjustment in a predetermined ratio.

It should be understood that the signal adjustment process may involve at least one of adjusting the low-frequency part of the signal and adjusting the high-frequency part of the signal.

In step S216, the first input signal and the second input signal are combined to obtain a combined signal, where a proportion of the first input signal in the combined signal is reduced with an increase of frequency in a first predetermined frequency band, the first predetermined frequency band including a part of an overlapping frequency band of the first input signal and the second input signal where frequency is greater than a first predetermined frequency threshold.

According to an embodiment of the present disclosure, in the case that the gain adjustment ratio is determined by adopting the time domain analysis, the signal processing procedure can be expressed by formula (3):

$${y}_{FB} ( t , f ) = g * {x}_{F B}^{low} ( t , f ) \qquad ( 3 )$$

$$y ( t , f ) = {y}_{FB} ( t , f ) + {x}_{FF}^{high} ( t , f ) ,$$

where g represents the gain adjustment ratio,

$${x}_{F B}^{l o w} ( t , f )$$

represents the part of the first sound input signal with a frequency lower than the critical frequency,

$${x}_{F F}^{h i g h} ( t , f )$$

represents the part of the second sound input signal with a frequency higher than the critical frequency, y_{FB}(t, f) is the adjusted first sound input signal (i.e., the first input signal), and y(t, f) is the combined signal.

It can be seen that the combined signal y(t, f) can be based on the adjusted first sound input signal y_{FB}(t, f) and the second sound input signal (i.e., the part

$${x}_{F F}^{h i g h} ( t , f )$$

of the second sound input signal with a frequency higher than the critical frequency). It should be understood that the adjusted first sound input signal y_{FB}(t, f) and the part

$${x}_{F F}^{h i g h} ( t , f )$$

of the second sound input signal with a frequency higher than the critical frequency can be directly concatenated to obtain a combined signal y(t, f). Further, in order to enable the adjusted first sound input signal y_{FB}(t, f) and the part

$${x}_{F F}^{h i g h} ( t , f )$$

of the second sound input signal with a frequency higher than the critical frequency to transition smoothly, both of them can further be smoothed during the combination process, and the signal obtained after smoothing can be used as the combined signal.

According to another embodiment of the present disclosure, when the gain adjustment ratio is determined based on at least one of the first gain adjustment ratio gᵢₙₜₑᵣ and the second gain adjustment ratio gᵢₙₜᵣₐ, the signal processing procedure can be expressed by formula (4):

$${y}_{F B} ( t , f ) = {g}_{inter} * {x}_{F B}^{l o w} ( t , f ) \qquad ( 4 )$$

$${y}_{F F} ( t , f ) = {g}_{i n t r a} * {x}_{FF}^{high} ( t , f )$$

$$y ( t , f ) = {y}_{F B} ( t , f ) + {y}_{F F} ( t , f ) ,$$

where y_{FF}(t, f) is the adjusted second sound input signal (i.e., the second input signal).

It can be seen that the combined signal y(t, f) can be determined based on the adjusted first sound input signal y_{FB}(t, f) and the adjusted second sound input signal y_{FF}(t, f). It should be understood that the adjusted first sound input signal y_{FB}(t, f) and adjusted second sound input signal y_{FF}(t, f) can be directly concatenated to obtain a combined signal y(t, f). Further, in order to enable the adjusted first sound input signal y_{FB}(t, f) and the adjusted second sound input signal y_{FF}(t, f) to transition smoothly, both of them can further be smoothed during the combination process, and the signal obtained after smoothing can be used as the combined signal.

According to yet another embodiment of the present disclosure, when a gain ratio between the signal response of the built-in microphone and the signal response of the external microphone is determined for each frequency bin in the frequency domain analysis to determine the gain adjustment ratio, the signal processing procedure can be expressed by formula (5):

$${y}_{F B} ( t , f ) = g ( t , f ) * {x}_{F B}^{l o w} ( t , f ) \qquad ( 5 )$$

$$y ( t , f ) = {y}_{F B} ( t , f ) + {x}_{F F}^{high} ( t , f ) ,$$

where the gain adjustment ratio g(t, f) is related to time t and frequency f.

It can be seen that the combined signal y(t, f) can be based on the adjusted first sound input signal y_{FB}(t, f) and the second sound input signal (i.e., the part

$${x}_{F F}^{h i g h} ( t , f )$$

of the second sound input signal with a frequency higher than the critical frequency). It should be understood that the adjusted first sound input signal y_{FB}(t, f) and the part

$${x}_{F F}^{h i g h} ( t , f )$$

of the second sound input signal with a frequency higher than the critical frequency can be directly concatenated to obtain a combined signal y(t, f). Further, in order to enable the adjusted first sound input signal y_{FB}(t, f) and the part

$${x}_{F F}^{h i g h} ( t , f )$$

of the second sound input signal with a frequency higher than the critical frequency to transition smoothly, both of them can further be smoothed during the combination process, and the signal obtained after smoothing can be used as the combined signal.

According to an embodiment of the present disclosure, in order to smoothly combine signals, the signals can be smoothed. For example, when combining the first input signal and the second input signal, for a frequency band lower than a lower frequency limit of the first predetermined frequency band, the first input signal and the second input signal can be combined according to a first combination ratio to obtain a first combined signal; for a frequency band within the first predetermined frequency band, the first input signal and the second input signal can be combined according to a second combination ratio that is reduced with an increase of frequency to obtain a second combined signal; for a frequency band higher than an upper frequency limit of the first predetermined frequency band, the first input signal and the second input signal can be combined according to a third combination ratio to obtain a third combined signal; and then the combined signal can be determined based on the first combined signal, the second combined signal, and the third combined signal (e.g., the first combined signal, the second combined signal, and the third combined signal are all concatenated and combined according to the frequency distribution), where the first combination ratio, the second combination ratio, and the third combination ratio all represent proportion of the first input signal in the combined signal, where the first combination ratio is greater than the second combination ratio, and the second combination ratio is greater than the third combination ratio.

It should be understood that reducing the proportion of the first input signal in the combined signal with an increase of frequency in the first predetermined frequency band can be achieved through software (e.g., by adjusting the parameter of the second combination ratio through software), or reducing the proportion of the first input signal in the combined signal with an increase of frequency in the first predetermined frequency band can be achieved through hardware (e.g., through circuit elements or a combination thereof).

According to an embodiment of the present disclosure, in the case where reducing the proportion of the first input signal in the combined signal with an increase of frequency in the first predetermined frequency band is achieved through software, the first input signal can be filtered by using a low-pass filter to obtain a filtered first input signal, and the second input signal can be filtered by using a high-pass filter to obtain a filtered second input signal, where the allowed pass frequency bands of the low-pass filter and the high-pass filter both include the first predetermined frequency band; and the filtered first input signal and the filtered second input signal are combined to obtain the combined signal.

Combining the first input signal and the second input signal in the above manner can avoid level jumps in the combined signal, and can ensure that the sound output by the sound output apparatus based on the combined signal is more natural.

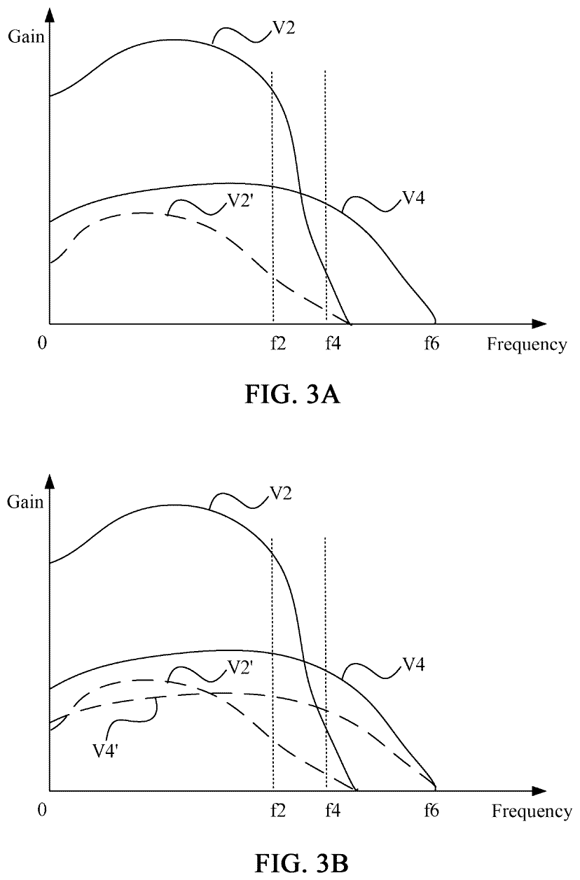

In order to better understand the signal adjustment process of step S214 and the signal smooth combination process of step S216, description is made here in conjunction with FIGS. 3A and 3B.

As shown in FIG. 3A, assuming that the gain ratio between the signal response of the built-in microphone and the signal response of the external microphone is 3, the gain of the first sound input signal V2 can be reduced to 1/3 of the original one to obtain a first input signal V2′; and then the first input signal V2′ can be combined with the second sound input signal V4 to obtain a combined signal. During the combination process, for a frequency band where frequency is lower than f2 (i.e., a frequency band where frequency is between 0 and f2), the first input signal and the second input signal can be combined according to a first combination ratio to obtain a first combined signal; for a frequency band where frequency is between f2 and f4, the first input signal and the second input signal can be combined according to a second combination ratio that is reduced with an increase of frequency to obtain a second combined signal; for a frequency band where frequency is higher than f4 (i.e., a frequency band where frequency is between f4 and f6), the first input signal and the second input signal can be combined according to a third combination ratio to obtain a third combined signal; and then the combined signal can be determined based on the first combined signal, the second combined signal, and the third combined signal. The first combination ratio, the second combination ratio, and the third combination ratio all represent the proportion of the first input signal in the combined signal. As an example, the first combination ratio may be 1/2, the third combination ratio may be 1/5, and the second combination ratio may be between 0 and 1/5.

As shown in FIG. 3B, assuming that the gain ratio between the signal response of the built-in microphone and the signal response of the external microphone is 3, the gain of the first sound input signal V2 can be reduced to 1/3 of the original one to obtain a first input signal V2′; the gain of the second sound input signal V2 can be reduced to 2/3 of the original one to obtain a second input signal V4′; and then the first input signal V2′ can be combined with the second input signal V4′ to obtain a combined signal. During the combination process, for a frequency band where frequency is lower than f2 (i.e., a frequency band where frequency is between 0 and f2), the first input signal and the second input signal can be combined according to a first combination ratio to obtain a first combined signal; for a frequency band where frequency is between f2 and f4, the first input signal and the second input signal can be combined according to a second combination ratio that is reduced with an increase of frequency to obtain a second combined signal; for a frequency band where frequency is higher than f4 (i.e., a frequency band where frequency is between f4 and f6), the first input signal and the second input signal can be combined according to a third combination ratio to obtain a third combined signal; and then the combined signal can be determined based on the first combined signal, the second combined signal, and the third combined signal. The first combination ratio, the second combination ratio, and the third combination ratio all represent the proportion of the first input signal in the combined signal. As an example, the first combination ratio may be 2/3, the third combination ratio may be 0, and the second combination ratio may be between 0 and 2/3.

Returning to FIG. 2A, in order to further improve the quality of the combined signal, optionally, the signal processing method 210 may further include step S218.

In step S218, the noise in the combined signal is reduced to obtain a first noise-reduced signal by using a neural network model, where the neural network model has a higher noise reduction ability for low-frequency signals than high-frequency signals.

According to an embodiment of the present disclosure, the neural network model can achieve noise reduction for the combined signal by analyzing the energy, amplitude, variation trend, and other characteristics of the combined signal.

According to an embodiment of the present disclosure, the neural network model can be trained by calculating the value of a loss function, the calculation of the loss function being related to the frequency of the signal, where the loss function has a greater penalty value for low-frequency signals than for high-frequency signals. For example, the penalty value may be inversely proportional to the magnitude of the frequency of the signal, or a penalty value F1 can be set for a frequency band corresponding to low-frequency signals, and a penalty value F2 can be set for a frequency band corresponding to high-frequency signals, where F1>F2. By setting the loss function to have a greater penalty value for low-frequency signals than for high-frequency signals in the stage of training the neural network model, the trained neural network model can have a higher noise reduction ability for low-frequency signals than for high-frequency signals.

According to an embodiment of the present disclosure, the noise in the first input signal can be reduced to obtain a second noise-reduced signal by using the neural network model; and the first noise-reduced signal and the second noise-reduced signal can be combined to obtain a noise-reduced combined signal.

It should be understood that the process of combining the first noise-reduced signal and the second noise-reduced signal may be implemented in various implementations similar to the process of combining the first input signal and the second input signal as described above.

For example, a third gain adjustment ratio can determined based on a gain ratio between the first noise-reduced signal and the second noise-reduced signal; at least one of the first noise-reduced signal and the second noise-reduced signal can be adjusted based on the third gain adjustment ratio to obtain a third noise-reduced signal and a fourth noise-reduced signal; and the third noise-reduced signal and the fourth noise-reduced signal can be combined to obtain the noise-reduced combined signal, where a proportion of the fourth noise-reduced signal in the noise-reduced combined signal is reduced with an increase of frequency in the second predetermined frequency band, the second predetermined frequency band including a part of an overlapping frequency band of the third noise-reduced signal and the fourth noise-reduced signal where frequency is greater than a second predetermined frequency threshold.

According to an embodiment of the present disclosure, for a frequency band where frequency is lower than a lower frequency limit of the second predetermined frequency band, the first noise-reduced signal and the second noise-reduced signal can be combined according to a fourth combination ratio to obtain a fourth combined signal; for a frequency band where frequency is within the second predetermined frequency band, the first noise-reduced signal and the second noise-reduced signal can be combined according to a fifth combination ratio that is reduced with an increase of frequency to obtain a sixth combined signal; for a frequency band where frequency is higher than an upper frequency limit of the second predetermined frequency band, the first noise-reduced signal and the second noise-reduced signal can be combined according to a sixth combination ratio to obtain a sixth combined signal; and then the combined signal can be determined based on the fourth combined signal, the fifth combined signal, and the sixth combined signal (e.g., the fourth combined signal, the fifth combined signal, and the sixth combined signal are all concatenated and combined according to the frequency distribution), where the fourth combination ratio, the fifth combination ratio, and the sixth combination ratio all represent proportion of the second noise-reduced signal in the combined signal, where the fourth combination ratio is greater than the fifth combination ratio, and the fifth combination ratio is greater than the sixth combination ratio.

It should be understood that reducing the proportion of the fourth noise-reduced signal in the noise-reduced combined signal with an increase of frequency in the second predetermined frequency band can be achieved through software (e.g., by adjusting the parameter of the fifth combination ratio through software), or reducing the proportion of the fourth noise-reduced signal in the noise-reduced combined signal with an increase of frequency in the second predetermined frequency band can be achieved through hardware (e.g., through circuit elements or a combination thereof).

FIG. 2B is a schematic flowchart illustrating a signal processing method 220 according to an embodiment of the present disclosure.

In step S222, a gain adjustment ratio is determined based on a gain ratio between a first sound input signal generated based on a built-in microphone of an electronic device and a second sound input signal generated based on an external microphone of the electronic device.

According to an embodiment of the present disclosure, a gain ratio between the first sound input signal and the second sound input signal can be acquired by adopting at least one of time domain analysis and frequency domain analysis to determine the gain adjustment ratio.

In a case that the gain adjustment ratio is determined by adopting the time domain analysis, low-pass filtering can be performed on the first sound input signal and the second sound input signal respectively to obtain a first filtered signal and a second filtered signal; and the gain adjustment ratio can be determined based on a gain ratio between the first filtered signal and the second filtered signal.

In a case that the gain adjustment ratio is determined by adopting the frequency domain analysis, a critical frequency at which a gain in the first sound input signal is greater than or equal to a predetermined gain threshold can be determined; a first gain adjustment ratio can be determined based on a first sound input ratio between the first sound input signal and the second sound input signal when a frequency is lower than the critical frequency and a second gain ratio between the first sound input signal and the second sound input signal when the frequency is greater than or equal to the critical frequency; a second gain adjustment ratio can be determined based on a third gain ratio between the second sound input signal when the frequency is lower than the critical frequency and the second sound input signal when the frequency is greater than or equal to the critical frequency; and the gain adjustment ratio can be determined based on at least one of the first gain adjustment ratio and the second gain adjustment ratio. For the embodiment shown in FIG. 2B, the first gain adjustment ratio and the second gain adjustment ratio can be calculated similarly to formulas (1) and (2), which will not be described in detail herein.

In the case that the gain adjustment ratio is determined by the frequency domain analysis, the gain ratio between the first sound input signal and the second sound input signal can further be determined for each frequency bin in the frequency domain analysis to determine the gain adjustment ratio.

In step S224, at least one of the first sound input signal and the second sound input signal is adjusted based on the gain adjustment ratio, to obtain a first input signal and a second input signal.

In step S226, the first input signal and the second input signal are combined to obtain a combined signal, where a proportion of the first input signal in the combined signal is reduced with an increase of frequency in a first predetermined frequency band, the first predetermined frequency band including a part of an overlapping frequency band of the first input signal and the second input signal where frequency is greater than a first predetermined frequency threshold.

In order to further improve the quality of the combined signal, optionally, the signal processing method 220 may further include step S228.

In step S228, the noise in the combined signal is reduced to obtain a first noise-reduced signal by using a neural network model, where the neural network model has a higher noise reduction ability for low-frequency signals than high-frequency signals.

It should be understood that step S224, step S226, and step S228 can be implemented similarly to step S214, step S216, and step S218 described above, respectively, which will not be described in detail herein.

FIG. 2C is a schematic flowchart illustrating a signal processing method 230 according to an embodiment of the present disclosure.

In step S232, a first sound input signal generated based on a built-in microphone of an electronic device, a second sound input signal generated based on an external microphone of the electronic device, and an expected signal response are acquired.

According to an embodiment of the present disclosure, the expected response reflects the ideal gain characteristic of the signal generated by the microphone for the input sound, which can be obtained based on a plurality of tests of the microphone. The expected signal response may be reflected by the energy or amplitude of the signal. For example, the expected signal response may be the ideal impulse response or frequency response of the microphone.

In step S234, at least one of the first sound input signal and the second sound input signal is adjusted based on the expected signal response to obtain a first input signal and a second input signal.

According to an embodiment of the present disclosure, at least one of the first sound input signal and the second sound input signal can be adjusted in the time domain to obtain the first input signal and the second input signal; or at least one of the first sound input signal and the second sound input signal can be adjusted in the frequency domain to obtain the first input signal and the second input signal.

It should be understood that the process of adjusting at least one of the first sound input signal and the second sound input signal based on the expected signal response can be implemented in a process similar to that of FIGS. 3A and 3B. The difference lies in the first sound input signal and/or the second sound input signal that need to be adjusted are both adjusted with the expected signal response as the standard, so that the first input signal and/or the second input signal obtained after adjustment have gain characteristics similar to the expected signal response.

In step S236, the first input signal and the second input signal are combined to obtain a combined signal, where a proportion of the first input signal in the combined signal is reduced with an increase of frequency in a first predetermined frequency band, the first predetermined frequency band including a part of an overlapping frequency band of the first input signal and the second input signal where frequency is greater than a first predetermined frequency threshold.

According to an embodiment of the present disclosure, when the first sound input signal is adjusted based on the expected signal response, the signal processing procedure can be expressed by formula (6):

$$g ( t , f ) = \frac{\vert {H}_{T I M} ( t , f ) \vert}{\vert {H}_{F B} ( t , f ) \vert + ε} \qquad ( 6 )$$

$${y}_{F B} ( t , f ) = g ( t , f ) * {x}_{F B}^{low} ( t , f )$$

$$y ( t , f ) = {y}_{FB} ( t , f ) + {x}_{F F}^{h i g h} ( t , f )$$

The signal processing procedure shown in formula (6) is directed to each frequency bin in the frequency domain analysis, where the center frequency range of each frequency bin is between 0 and fs, fs is the maximum sampling frequency of the signal response, the gain adjustment ratio g(t, f) is related to time t and frequency f, |H_{TIM}(t, f)| is the value of the expected signal response, |H_{FB}(t, f)| is the value of the signal response of the built-in microphone, and the predetermined parameter ε is used for preventing the denominator from being 0.

It can be seen that the combined signal y(t, f) can be determined based on the adjusted first sound input signal y_{FB}(t, f) and the second sound input signal (i.e., the part

$${x}_{F F}^{h i g h} ( t , f )$$

of the second sound input signal with a frequency higher than the critical frequency). It should be understood that the adjusted first sound input signal y_{FB}(t, f) and the part

$${x}_{F F}^{h i g h} ( t , f )$$

of the second sound input signal with a frequency higher than the critical frequency can be directly concatenated to obtain a combined signal y(t, f). Further, in order to enable the adjusted first sound input signal y_{FB}(t, f) and the part

$${x}_{F F}^{h i g h} ( t , f )$$

of the second sound input signal with a frequency higher than the critical frequency to transition smoothly, both of them can further be smoothed during the combination process, and the signal obtained after smoothing can be used as the combined signal.

In order to further improve the quality of the combined signal, optionally, the signal processing method 230 may further include step S238.

In step S238, the noise in the combined signal is reduced to obtain a first noise-reduced signal by using a neural network model, where the neural network model has a higher noise reduction ability for low-frequency signals than high-frequency signals.

It should be understood that step S236 can be implemented similarly to step S216 or step S226 described above respectively, and step S238 can be implemented similarly to step S218 or step S228 described above respectively, which will not be described in detail herein.

According to an embodiment of the present disclosure, the signal processing method 210, signal processing method 220, and signal processing method 230 described above can all be executed by the processor 114 in the electronic device 110 described in FIG. 1A, or by the processor 124 in the electronic device 120 described in FIG. 1B. The signal processing method 210, signal processing method 220, and signal processing method 230 described above perform gain adjustment on at least one of a sound input signal generated based on a built-in microphone of the electronic device and a sound input signal generated based on an external microphone of the electronic device, and smoothly combine the adjusted signals. In this way, a combined signal of higher quality (i.e., a signal that is clearer and better able to reflect the information of the real sound) can be obtained even in the case of a low signal-to-noise ratio of the sound input signal generated based on the external microphone of the electronic device. Further, the noise in the combined signal can be reduced by a neural network model to further improve the quality of the combined signal. Processing the signal by the signal processing method of the present disclosure can make the sound output at the sound output apparatus 116 in FIG. 1A or the sound output apparatus 134 in FIG. 1B clearer and more real, thereby improving the user experience.

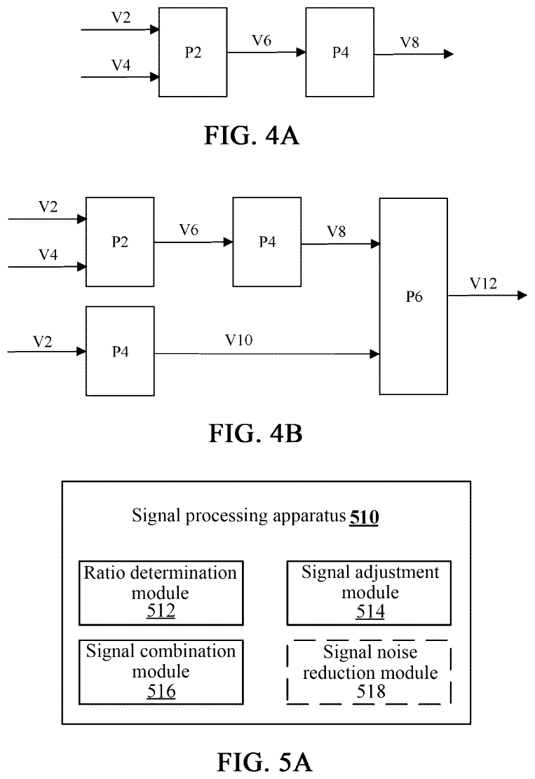

FIG. 4A is a schematic diagram illustrating a signal processing procedure according to an embodiment of the present disclosure.

As shown in FIG. 4A, after acquiring the first sound input signal V2 generated based on the built-in microphone of the electronic device and the second sound input signal V4 generated based on the external microphone of the electronic device, the first sound input signal V2 and the second sound input signal V4 can be adjusted and smoothly combined (i.e., processing P2 shown in FIG. 4A) to obtain a combined signal V6. The combined signal V6 has information in the entire frequency band and is less susceptible to wind noise, and can more clearly and truly reflect the information of the sound input to the microphone.

According to an embodiment of the present disclosure, the processing P2 may include at least one of steps S212 to S216 shown in FIG. 2A, steps S222 to S226 shown in FIG. 2B, and steps S232 to S236 shown in FIG. 2C.

Further, the noise in the combined signal V6 can be reduced by using a neural network model (i.e., processing P4 shown in FIG. 4A) to obtain a first noise-reduced signal V8. By providing the first noise-reduced signal V8 to the sound output apparatus, the clarity and realness of the sound heard by the user can be significantly improved.

FIG. 4B is a schematic diagram illustrating a signal processing procedure according to another embodiment of the present disclosure.

As shown in FIG. 4B, on the basis of the embodiment shown in FIG. 4A, noise reduction can be performed on the first sound input signal V2 additionally by using a neural network model to obtain a second noise-reduced signal V10.

Further, the first noise-reduced signal V8 and the second noise-reduced signal V10 can be adjusted and smoothly combined (i.e., processing P6 shown in FIG. 4B) to obtain a combined signal V12.

According to an embodiment of the present disclosure, the processing P6 can be implemented similarly to steps S222 to S226 shown in FIG. 2B.

By providing the combined signal V12 to the sound output apparatus, the clarity and authenticity of the sound heard by the user can be significantly improved.

Compared with the signal processing procedure shown in FIG. 4A, the signal processing procedure shown in FIG. 4B can more fully utilize the information of the first sound input signal generated by the built-in microphone of the electronic device to improve the clarity of the low-frequency part of the signal.

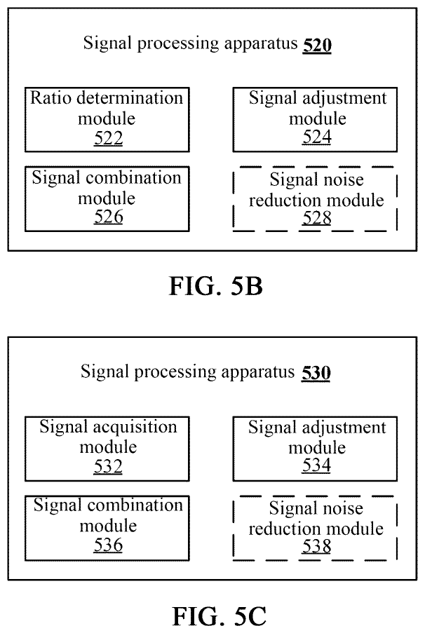

FIG. 5A is a schematic diagram illustrating the composition of a signal processing apparatus 510 according to an embodiment of the present disclosure.

According to an embodiment of the present disclosure, the signal processing apparatus 510 includes a ratio determination module 512, a signal adjustment module 514, and a signal combination module 516. Optionally, the signal processing apparatus 510 may further include a signal noise reduction module 518.

The ratio determination module 512 can be configured to: determine a gain adjustment ratio between a first sound input signal generated based on a built-in microphone of an electronic device and a second sound input signal generated based on an external microphone of the electronic device, based on respective signal responses of the built-in microphone and the external microphone.

The signal adjustment module 514 can be configured to: adjust at least one of the first sound input signal and the second sound input signal based on the gain adjustment ratio, to obtain a first input signal and a second input signal.

The signal combination module 516 can be configured to: combine the first input signal and the second input signal to obtain a combined signal, where a proportion of the first input signal in the combined signal is reduced with an increase of frequency in a first predetermined frequency band, the first predetermined frequency band including a part of an overlapping frequency band of the first input signal and the second input signal where frequency is greater than a first predetermined frequency threshold.

The signal noise reduction module 518 can be configured to: reduce the noise in the combined signal to obtain a first noise-reduced signal by using a neural network model, where the neural network model has a higher noise reduction ability for low-frequency signals than high-frequency signals.

It should be understood that the signal processing apparatus 510 in FIG. 5A can implement the signal processing method 210 described with respect to FIG. 2A, where the ratio determination module 512, the signal adjustment module 514, the signal combination module 516, and the signal noise reduction module 518 can be used for implementing the processing procedures described with respect to step S212, step S214, step S216, and step S218, respectively, which will not be described in detail herein.

According to an embodiment of the present disclosure, the signal processing apparatus 510 can be used in the electronic device 110 described with respect to FIG. 1A. For example, the signal processing apparatus 510 can be used for implementing some of the functions of the processor 114. Alternatively, the signal processing apparatus 510 can also be used in the electronic device 120 described with respect to FIG. 1B. For example, the signal processing apparatus 510 can be used for implementing some of the functions of the processor 124.

FIG. 5B is a schematic diagram illustrating the composition of a signal processing apparatus 520 according to an embodiment of the present disclosure.

According to an embodiment of the present disclosure, the signal processing apparatus 520 includes a ratio determination module 522, a signal adjustment module 524, and a signal combination module 526. Optionally, the signal processing apparatus 520 may further include a signal noise reduction module 528.

The ratio determination module 522 can be configured to: determine a gain adjustment ratio based on a gain ratio between a first sound input signal generated based on a built-in microphone of an electronic device and a second sound input signal generated based on an external microphone of the electronic device.

The signal adjustment module 524 can be configured to: adjust at least one of the first sound input signal and the second sound input signal based on the gain adjustment ratio, to obtain a first input signal and a second input signal.

The signal combination module 526 can be configured to: combine the first input signal and the second input signal to obtain a combined signal, where a proportion of the first input signal in the combined signal is reduced with an increase of frequency in a first predetermined frequency band, the first predetermined frequency band including a part of an overlapping frequency band of the first input signal and the second input signal where frequency is greater than a first predetermined frequency threshold.

The signal noise reduction module 528 can be configured to: reduce the noise in the combined signal to obtain a first noise-reduced signal by using a neural network model, where the neural network model has a higher noise reduction ability for low-frequency signals than high-frequency signals.

It should be understood that the signal processing apparatus 520 in FIG. 5B can implement the signal processing method 220 described with respect to FIG. 2B, where the ratio determination module 522, the signal adjustment module 524, the signal combination module 526, and the signal noise reduction module 528 can be used for implementing the processing procedures described with respect to step S222, step S224, step S226, and step S228, respectively, which will not be described in detail herein.

According to an embodiment of the present disclosure, the signal processing apparatus 520 can be used in the electronic device 110 described with respect to FIG. 1A. For example, the signal processing apparatus 520 can be used for implementing some of the functions of the processor 114. Alternatively, the signal processing apparatus 520 can also be used in the electronic device 120 described with respect to FIG. 1B. For example, the signal processing apparatus 520 can be used for implementing some of the functions of the processor 124.

FIG. 5C is a schematic diagram illustrating the composition of a signal processing apparatus 530 according to an embodiment of the present disclosure.

According to an embodiment of the present disclosure, the signal processing apparatus 530 includes a signal acquisition module 532, a signal adjustment module 534, and a signal combination module 536. Optionally, the signal processing apparatus 530 may further include a signal noise reduction module 538.

The signal acquisition module 532 can be configured to: acquire a first sound input signal generated based on a built-in microphone of an electronic device, a second sound input signal generated based on an external microphone of the electronic device, and an expected signal response.

The signal adjustment module 534 can be configured to: adjust at least one of the first sound input signal and the second sound input signal based on the expected signal response to obtain a first input signal and a second input signal.

The signal combination module 536 can be configured to: combine the first input signal and the second input signal to obtain a combined signal, where a proportion of the first input signal in the combined signal is reduced with an increase of frequency in a first predetermined frequency band, where the first predetermined frequency band includes a part of an overlapping frequency band of the first input signal and the second input signal, where frequency in the part of the overlapping frequency band is greater than a first predetermined frequency threshold.

The signal noise reduction module 538 can be configured to: reduce the noise in the combined signal to obtain a first noise-reduced signal by using a neural network model, where the neural network model has a higher noise reduction ability for low-frequency signals than high-frequency signals.

It should be understood that the signal processing apparatus 530 in FIG. 5C can implement the signal processing method 230 described with respect to FIG. 2C, where the signal acquisition module 532, the signal adjustment module 534, the signal combination module 536, and the signal noise reduction module 538 can be used for implementing the processing procedures described with respect to step S232, step S234, step S236, and step S238, respectively, which will not be described in detail herein.

According to an embodiment of the present disclosure, the signal processing apparatus 530 can be used in the electronic device 110 described with respect to FIG. 1A. For example, the signal processing apparatus 530 can be used for implementing some of the functions of the processor 114. Alternatively, the signal processing apparatus 530 can also be used in the electronic device 120 described with respect to FIG. 1B. For example, the signal processing apparatus 530 can be used for implementing some of the functions of the processor 124.

According to yet another aspect of the present disclosure, a computer-readable storage medium is provided. The computer-readable storage medium has computer-readable instructions stored thereon. The computer-readable instructions, when executed by a processor, can execute the method according to the embodiments of the present disclosure described with reference to the drawings above. The computer-readable storage medium in the embodiments of the present disclosure may be a volatile memory or a nonvolatile memory, or may include both a volatile and a nonvolatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), which is used as an external cache. By way of example and not limitation, many forms of RAM are available, such as static random access memory (SRAM), dynamic random access memory (DRAM), synchronous dynamic random access memory (SDRAM), double data rate synchronous dynamic random access memory (DDRSDRAM), enhanced synchronous dynamic random access memory (ESDRAM), synchronous linked dynamic random access memory (SLDRAM), and direct memory bus random access memory (DR RAM). It should be noted that memory of the methods described herein is intended to include, but is not limited to, these and any other suitable types of memory. It should be noted that memory of the methods described herein is intended to include, but is not limited to, these and any other suitable types of memory.

An embodiment of the present disclosure further provides a computer program product or a computer program. The computer program product or the computer program includes computer instructions stored in a computer-readable storage medium. The processor of the computer device reads the computer instructions from the computer-readable storage medium, and the processor executes the computer instructions to cause the computer device to execute the method according to the embodiments of the present disclosure.

An embodiment of the present disclosure further provides a signal processing device, including: a memory and a processor coupled to the memory and configured to execute the method according to the embodiments of the present disclosure.

In summary, the present disclosure provides a signal processing method, device, and apparatus, and a computer-readable storage medium. The signal processing method includes: determining a gain adjustment ratio between a first sound input signal generated based on the built-in microphone of the electronic device and a second sound input signal generated based on the external microphone of the electronic device, based on respective signal responses of the built-in microphone and the external microphone; adjusting at least one of the first sound input signal and the second sound input signal based on the gain adjustment ratio, to obtain a first input signal and a second input signal; and combining the first input signal and the second input signal to obtain a combined signal, where a proportion of the first input signal in the combined signal is reduced with an increase of frequency in a first predetermined frequency band, the first predetermined frequency band including a part of an overlapping frequency band of the first input signal and the second input signal where frequency is greater than a first predetermined frequency threshold.

The signal processing method of the present disclosure performs gain adjustment on at least one of a sound input signal generated based on a built-in microphone of an electronic device and a sound input signal generated based on an external microphone of the electronic device, and smoothly combines the adjusted signals. In this way, a combined signal of higher quality (i.e., a signal that is clearer and better able to reflect the information of the real sound) can be obtained in the case of a low signal-to-noise ratio of the sound input signal generated based on the external microphone of the electronic device. Further, the noise in the combined signal can be reduced by a neural network model to further improve the quality of the combined signal. The signal processing method of the present disclosure can improve the user experience in application scenarios such as sound acquisition and voice communication.

It should be noted that the flowcharts and block diagrams in the drawings illustrate possible architectures, functions, and operations of systems, methods, and computer program products according to various embodiments of the present disclosure. In this regard, each block in the flowcharts or block diagrams may represent a module, a program segment, or a portion of code, which contains at least one executable instruction for implementing the specified logical function. It should also be noted that, in some alternative implementations, the functions noted in the blocks may occur in an order other than that noted in the drawings. For example, two blocks shown in succession may actually be executed substantially in parallel, or they may sometimes be executed in the reverse order, depending on the functionality involved. It should also be noted that each box in the block diagrams and/or flowcharts and combinations of boxes in the block diagrams and/or flowcharts can be implemented by a dedicated hardware-based system that performs the specified function or operation, or can be implemented by a combination of dedicated hardware and computer instructions.

Specific words are used in the present disclosure to describe the embodiments of the present disclosure. For example, “first/second embodiment”, “an embodiment”, and/or “some embodiments” mean a feature, structure, or characteristic associated with at least one embodiment of the present disclosure. Accordingly, it should be emphasized and noted that “an embodiment” or “one embodiment” or “an alternative embodiment” referred to two or more times in different places in this specification does not necessarily refer to the same embodiment. In addition, some features, structures, or characteristics of one or more embodiments of the present disclosure may be combined as appropriate.

In the embodiments of the present disclosure, the term “module” or “unit” refers to a computer program or a segment of a computer program that has a predetermined function and works together with other related parts to achieve a predetermined goal, and can be implemented entirely or in part by using software, hardware (such as a processing circuit or memory), or a combination thereof. Likewise, one processor (or a plurality of processors or memories) can be used for implementing one or more modules or units. Further, each module or unit may be a part of an integral module or unit that includes the function of the module or unit.

It should be noted that in the present disclosure, the terms “comprises”, “includes”, or any other variations thereof are intended to cover non-exclusive inclusion, so that a process, method, article, or device that includes a series of elements includes not only those elements, but also includes other elements that are not explicitly listed, or also includes elements that are inherent to such process, method, article, or device. Without more constraints, an element defined by the phrase “comprising a . . . ” does not exclude the existence of other identical elements in the process, method, article, or device comprising the element.

Further, the series of processes described above include not only processes executed in time series in the order described herein but also processes executed in parallel or separately, not in time series.

Unless otherwise defined, all terms used herein, including technical and scientific terms, have the same meaning as commonly understood by those of ordinary skill in the art to which the present disclosure belongs. It should also be understood that terms such as those defined in common dictionaries should be construed as having a meaning consistent with their meaning in the context of the relevant technology and should not be construed with idealized or extremely formalized meanings unless expressly defined as such herein.

The foregoing is a description of the present disclosure and should not be considered a limitation thereof. Although several exemplary embodiments of the present disclosure are described, it will be readily understood by those skilled in the art that many modifications can be made to the exemplary embodiments without departing from the novel teachings and advantages of the present disclosure. Accordingly, all such modifications are intended to be encompassed within the scope of the present disclosure as defined by the claims. It should be understood that the foregoing is a description of the present disclosure and should not be considered to be limited to the particular embodiments as disclosed, and that modifications to the disclosed embodiments, as well as other embodiments, are intended to be encompassed within the scope of the claims. The present disclosure is defined by the claims and equivalents thereof.

What is claimed is:

1. A signal processing method, comprising:
determining a gain adjustment ratio between a first sound input signal generated based on a built-in microphone of an electronic device and a second sound input signal generated based on an external microphone of the electronic device, based on respective signal responses of the built-in microphone and the external microphone;
adjusting at least one of the first sound input signal and the second sound input signal based on the gain adjustment ratio, to obtain a first input signal and a second input signal; and
combining the first input signal and the second input signal to obtain a combined signal, wherein a proportion of the first input signal in the combined signal is reduced with an increase of frequency in a first predetermined frequency band, the first predetermined frequency band including a part of an overlapping frequency band of the first input signal and the second input signal where frequency is greater than a first predetermined frequency threshold.

2. The signal processing method according to claim 1, wherein determining the gain adjustment ratio between the first sound input signal generated based on the built-in microphone of the electronic device and the second sound input signal generated based on the external microphone of the electronic device comprises:
obtaining a gain ratio between a signal response of the built-in microphone and a signal response of the external microphone to determine the gain adjustment ratio, by adopting at least one of time domain analysis or frequency domain analysis.

3. The signal processing method according to claim 2, wherein when adopting the time domain analysis the gain adjustment ratio is determined by:
performing low-pass filtering on the signal response of the built-in microphone and the signal response of the external microphone respectively to obtain a first filtered signal and a second filtered signal; and
determining the gain adjustment ratio based on a gain ratio between the first filtered signal and the second filtered signal.

4. The signal processing method according to claim 2, wherein when adopting the frequency domain analysis, the gain adjustment ratio is determined by:
determining a critical frequency at which a gain in the signal response of the built-in microphone is greater than or equal to a predetermined gain threshold;
determining a first gain adjustment ratio, based on a first gain ratio between the signal response of the built-in microphone and the signal response of the external microphone when a frequency is lower than the critical frequency and a second gain ratio between the signal response of the built-in microphone and the signal response of the external microphone when the frequency is greater than or equal to the critical frequency;
determining a second gain adjustment ratio, based on a third gain ratio between the signal response of the external microphone when the frequency is lower than the critical frequency and the signal response of the external microphone when the frequency is greater than or equal to the critical frequency; and
determining the gain adjustment ratio based on at least one of the first gain adjustment ratio or the second gain adjustment ratio.

5. The signal processing method according to claim 2, wherein when adopting the frequency domain analysis, the gain adjustment ratio is determined by:
determining a gain ratio between the signal response of the built-in microphone and the signal response of the external microphone for each frequency bin in the frequency domain analysis to determine the gain adjustment ratio.

6. The signal processing method according to claim 1, wherein combining the first input signal and the second input signal to obtain the combined signal comprises:
for a frequency band lower than a lower frequency limit of the first predetermined frequency band, combining the first input signal and the second input signal according to a first combination ratio to obtain a first combined signal;
for a frequency band within the first predetermined frequency band, combining the first input signal and the second input signal according to a second combination ratio that is reduced with an increase of frequency to obtain a second combined signal;
for a frequency band higher than an upper frequency limit of the first predetermined frequency band, combining the first input signal and the second input signal according to a third combination ratio to obtain a third combined signal; and
determining the combined signal based on the first combined signal, the second combined signal, and the third combined signal,
wherein the first combination ratio, the second combination ratio, and the third combination ratio each represent a proportion of the first input signal in the combined signal, wherein the first combination ratio is greater than the second combination ratio, and the second combination ratio is greater than the third combination ratio.

7. The signal processing method according to claim 6, wherein for a frequency band within the first predetermined frequency band, combining the first input signal and the second input signal according to the second combination ratio that is reduced with the increase of frequency comprises:
filtering the first input signal with a low-pass filter to obtain a filtered first input signal and filtering the second input signal with a high-pass filter to obtain a filtered second input signal, wherein allowable pass frequency bands of the low-pass filter and the high-pass filter both include the first predetermined frequency band; and
combining the filtered first input signal and the filtered second input signal to obtain the combined signal.

8. The signal processing method according to claim 1, further comprising: reducing noise in the combined signal to obtain a first noise-reduced signal by using a neural network model, wherein the neural network model has a higher noise reduction ability for low-frequency signals than high-frequency signals.

9. The signal processing method according to claim 8, further comprising:
reducing the noise in the first input signal to obtain a second noise-reduced signal by using the neural network model; and
combining the first noise-reduced signal and the second noise-reduced signal to obtain a noise-reduced combined signal.

10. The signal processing method according to claim 9, wherein combining the first noise-reduced signal and the second noise-reduced signal comprises:
determining a third gain adjustment ratio based on a gain ratio between the first noise-reduced signal and the second noise-reduced signal;
adjusting at least one of the first noise-reduced signal and the second noise-reduced signal based on the third gain adjustment ratio to obtain a third noise-reduced signal and a fourth noise-reduced signal; and
combining the third noise-reduced signal and the fourth noise-reduced signal to obtain the noise-reduced combined signal, wherein a proportion of the fourth noise-reduced signal in the noise-reduced combined signal is reduced with an increase of frequency in a second predetermined frequency band, the second predetermined frequency band including a part of an overlapping frequency band of the third noise-reduced signal and the fourth noise-reduced signal where frequency is greater than a second predetermined frequency threshold.

11. A signal processing device comprising:
a built-in microphone;
a memory; and
a processor coupled to the memory and configured to execute a method comprising the steps of:
determining a gain adjustment ratio between a first sound input signal generated based on the built-in microphone and a second sound input signal generated based on an external microphone, based on respective signal responses of the built-in microphone and the external microphone;
adjusting at least one of the first sound input signal and the second sound input signal based on the gain adjustment ratio, to obtain a first input signal and a second input signal; and
combining the first input signal and the second input signal to obtain a combined signal, wherein a proportion of the first input signal in the combined signal is reduced with an increase of frequency in a first predetermined frequency band, the first predetermined frequency band including a part of an overlapping frequency band of the first input signal and the second input signal where frequency is greater than a first predetermined frequency threshold.

12. The signal processing device of claim 11, wherein determining the gain adjustment ratio between the first sound input signal generated based on the built-in microphone of the electronic device and the second sound input signal generated based on the external microphone comprises:
obtaining a gain ratio between a signal response of the built-in microphone and a signal response of the external microphone to determine the gain adjustment ratio, by adopting at least one of time domain analysis or frequency domain analysis.

13. The signal processing device of claim 12, wherein when adopting the time domain analysis the gain adjustment ratio is determined by:
performing low-pass filtering on the signal response of the built-in microphone and the signal response of the external microphone respectively to obtain a first filtered signal and a second filtered signal; and
determining the gain adjustment ratio based on a gain.

14. The signal processing device of claim 12, wherein when adopting the frequency domain analysis, the gain adjustment ratio is determined by:
determining a critical frequency at which a gain in the signal response of the built-in microphone is greater than or equal to a predetermined gain threshold;
determining a first gain adjustment ratio, based on a first gain ratio between the signal response of the built-in microphone and the signal response of the external microphone when a frequency is lower than the critical frequency and a second gain ratio between the signal response of the built-in microphone and the signal response of the external microphone when the frequency is greater than or equal to the critical frequency;
determining a second gain adjustment ratio, based on a third gain ratio between the signal response of the external microphone when the frequency is lower than the critical frequency and the signal response of the external microphone when the frequency is greater than or equal to the critical frequency; and
determining the gain adjustment ratio based on at least one of the first gain adjustment ratio or the second gain adjustment ratio.

15. The signal processing device of claim 12, wherein when adopting the frequency domain analysis, the gain adjustment ratio is determined by:
determining a gain ratio between the signal response of the built-in microphone and the signal response of the external microphone for each frequency bin in the frequency domain analysis to determine the gain adjustment ratio.

16. The signal processing device of claim 13, wherein combining the first input signal and the second input signal to obtain the combined signal comprises:
for a frequency band lower than a lower frequency limit of the first predetermined frequency band, combining the first input signal and the second input signal according to a first combination ratio to obtain a first combined signal;
for a frequency band within the first predetermined frequency band, combining the first input signal and the second input signal according to a second combination ratio that is reduced with an increase of frequency to obtain a second combined signal;
for a frequency band higher than an upper frequency limit of the first predetermined frequency band, combining the first input signal and the second input signal according to a third combination ratio to obtain a third combined signal; and
determining the combined signal based on the first combined signal, the second combined signal, and the third combined signal,
wherein the first combination ratio, the second combination ratio, and the third combination ratio all represent proportion of the first input signal in the combined signal, wherein the first combination ratio is greater than the second combination ratio, and the second combination ratio is greater than the third combination ratio.

17. The signal processing device of claim 11, further comprising:
reducing noise in the combined signal to obtain a first noise-reduced signal by using a neural network model, wherein the neural network model has a higher noise reduction ability for low-frequency signals than high-frequency signals.

18. A computer-readable storage medium having computer-executable instructions stored thereon, which, when executed by a processor, cause the processor to perform the steps of:
determining a gain adjustment ratio between a first sound input signal generated based on a built-in microphone of an electronic device and a second sound input signal generated based on an external microphone of the electronic device, based on respective signal responses of the built-in microphone and the external microphone;
adjusting at least one of the first sound input signal and the second sound input signal based on the gain adjustment ratio, to obtain a first input signal and a second input signal; and
combining the first input signal and the second input signal to obtain a combined signal, wherein a proportion of the first input signal in the combined signal is reduced with an increase of frequency in a first predetermined frequency band, the first predetermined frequency band including a part of an overlapping frequency band of the first input signal and the second input signal where frequency is greater than a first predetermined frequency threshold.

19. The computer-readable storage medium of claim 18, wherein determining the gain adjustment ratio between the first sound input signal generated based on the built-in microphone of the electronic device and the second sound input signal generated based on the external microphone of the electronic device comprises:
obtaining a gain ratio between a signal response of the built-in microphone and a signal response of the external microphone to determine the gain adjustment ratio, by adopting at least one of time domain analysis or frequency domain analysis.

20. The computer-readable storage medium of claim 18, further comprising:
reducing noise in the combined signal to obtain a first noise-reduced signal by using a neural network model, wherein the neural network model has a higher noise reduction ability for low-frequency signals than high-frequency signals.
